(19) United States
(12) Patent Application Publication
(10) Pub. No.: US 2025/0237127 A1
(43) Pub. Date: Jul. 24, 2025

(54) HYDRAULIC FRACTURING FLUID COMPRISING MICROPROPPANT COKE PARTICLES, METHOD FOR MAKING SAME, AND HYDRAULIC FRACTURING PROCESSES USING SAME

(71) Applicant: ExxonMobil Technology and Engineering Company, Spring, TX (US)

(72) Inventors: Xiao JIN, Kingwood, TX (US); Lee J. HALL, The Woodlands, TX (US); Robert M. SHIRLEY, The Woodlands, TX (US); P. Matthew SPIECKER, Manvel, TX (US); Jonathan M. GIESEKE, Pinehurst, TX (US); George H. STAUS, Spring, TX (US)

(21) Appl. No.: 18/675,613

(22) Filed: May 28, 2024

Related U.S. Application Data
(63) Continuation-in-part of application No. 18/417,433, filed on Jan. 19, 2024, now abandoned.
(63) Continuation-in-part of application No. 18/417,478, filed on Jan. 19, 2024, now abandoned.
(63) Continuation-in-part of application No. 18/417,492, filed on Jan. 19, 2024, now abandoned.
(63) Continuation-in-part of application No. 18/417,488, filed on Jan. 19, 2024, now abandoned.
(63) Continuation-in-part of application No. 18/417,483, filed on Jan. 19, 2024, now abandoned.

(51) Int. Cl. E21B 43/267; C09K 8/80

(52) U.S. Cl. CPC E21B 43/267; C09K 8/80

(57) ABSTRACT

A fracturing fluid comprises a carrier fluid and coke particles. The coke particles include microproppant coke particles (e.g., petroleum coke fines) having particle sizes of at most 105 μm, where the microproppant coke particles have a total concentration of at least 3 wt % based on the total weight of the coke particles. The coke particles also have a total concentration in the fracturing fluid from 14 kilograms per cubic meter to 480 kilograms per cubic meter, based on the volume of the carrier fluid. A method includes introducing such fracturing fluid into a subterranean formation.

### CROSS-REFERENCE TO RELATED APPLICATION

This application claims priority to and the benefit of co-pending and commonly-assigned U.S. patent application Ser. No. 18/417,433, filed Jan. 19, 2024, titled “HYDRAULIC FRACTURING FLUID COMPRISING MICROPROPPANT COKE PARTICLES, METHOD FOR MAKING SAME, AND HYDRAULIC FRACTURING PROCESSES USING SAME,” co-pending and commonly-assigned U.S. patent application Ser. No. 18/417,478, filed Jan. 19, 2024, titled “METHODS FOR PERFORMING REFRACTURING OPERATIONS USING COKE PROPPANT PARTICLES,” co-pending and commonly-assigned U.S. patent application Ser. No. 18/417,492, filed Jan. 19, 2024, titled “PROPPANT PARTICLES FORMED FROM FLUID COKE AND FLEXICOKE, FRACTURING FLUIDS COMPRISING SUCH PROPPANT PARTICLES, AND METHODS RELATED THERETO,” co-pending and commonly-assigned U.S. patent application Ser. No. 18/417,488, filed Jan. 19, 2024, titled “HYDRAULIC FRACTURING METHODS UTILIZING COKE PROPPANT PARTICLES,” and co-pending and commonly-assigned U.S. patent application Ser. No. 18/417,483, filed Jan. 19, 2024, titled “METHODS FOR PRODUCING HYDROCARBON FLUIDS WITH REDUCED WATER-OIL RATIO BY UTILIZING OIL-WET PETROLEUM COKE PROPPANT PARTICLES DURING HYDRAULIC FRACTURING,” the contents of all of which are incorporated by reference herein in their entirety.

### FIELD

This disclosure relates generally to the field of hydraulic fracturing operations and proppant particles employed therein. More specifically, this disclosure relates to the utilization of microproppant coke particles such as those formed from petroleum coke fines during hydraulic fracturing operations.

### BACKGROUND

This section is intended to introduce various aspects of the art, which may be associated with embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A wellbore can be drilled into a subterranean formation to promote removal (or production) of a material such as hydrocarbon, coal, mineral, water, and the like. In many cases, the subterranean formation needs to be stimulated in some manner to promote removal of the resource. Stimulation can include any operation performed upon the matrix of a subterranean formation to improve fluid conductivity therethrough, including hydraulic fracturing, which is a commonly used for unconventional reservoirs.

Hydraulic fracturing typically involves the pumping of large quantities of fracturing fluid into a subterranean formation (e.g., a low-permeability formation) under high hydraulic pressure to promote the formation of one or more fractures within the matrix of the formation and to create high-conductivity flow paths. Primary fractures extending from the wellbore and, in some instances, secondary fractures extending from the primary fractures are formed during a fracturing operation. These fractures may be vertical, horizontal, or a combination of directions forming a tortuous path.

Proppant particles are often included in the fracturing fluid. Once the fracturing fluid has been pumped into the subterranean formation, it is desired that such proppant particles could be transported into the fractures and settle therein. Upon pressure release, the proppant particles remaining in the fractures keep the fractures open by preventing them from collapsing, facilitating the flow of desired products such as hydrocarbons from the fractured formations into the wellbore through the propped fractures. The performance of the proppant can affect the recovery of the intended products such as hydrocarbons significantly.

Sand has been traditionally used as a proppant in hydraulic fracturing for the production of hydrocarbon products from unconventional wells. Various other types of other proppants have been proposed and available to substitute sand. Nonetheless, all these existing proppants suffer from one of more drawbacks such as high cost and limited hydrocarbon recovery rate. Thus, there is a genuine need of high-performance proppants, hydraulic fracturing fluids, and hydraulic fracturing methods in the industry. This disclosure satisfies these and other needs.

### SUMMARY

An aspect of this disclosure provides a fracturing fluid comprising a carrier fluid and coke particles, where the coke particles comprise microproppant coke particles having particle sizes of at most 105 microns (μm). The microproppant coke particles may have a total concentration of at least 3 weight percent (wt %) based on the total weight of coke particles in the fracturing fluid. The coke particles may be present in the fracturing fluid at a concentration from about 14 kilograms per cubic meter (120 pound per 1000 gallons) to about 480 kilograms per cubic meter (4000 pound per 1000 gallons), based on the volume of the carrier fluid.

Another aspect of this disclosure provides a method for utilizing such fracturing fluid during a hydraulic fracturing operation. The method comprises introducing the fracturing fluid into a subterranean formation and depositing at least a portion of the microproppant coke particles within secondary fractures in the subterranean formation. The microproppant coke particles may have a total concentration of at least 3 weight percent (wt %) based on the total weight of coke particles in the fracturing fluid. The coke particles may be present in the fracturing fluid at a concentration from about 14 kilograms per cubic meter (120 pound per 1000 gallons) to about 480 kilograms per cubic meter (4000 pound per 1000 gallons), based on the volume of the carrier fluid.

Another aspect of this disclosure provides a method for making a fracturing fluid. The method comprises providing a first collection of coke particles comprising microproppant coke particles, where the microproppant coke particles have particle sizes of at most 105 μm. The method may comprise mixing the first collection of coke particles with at least a carrier fluid and optionally a second collection of proppant particles, where the total concentration of the microproppant coke particles is at least 3 wt % based on the total weight of the coke particles contained in the first collection of coke particles and the second collection of proppant particles. The coke particles may be mixed with the carrier fluid at a quantity from about 14 kilograms of the coke particles per cubic meter (120 pound per 1000 gallons) of the carrier fluid to about 480 kilograms of the coke particles per cubic meter (4000 pound per 1000 gallons) of the carrier fluid.

These and other features and attributes of the disclosed aspects and embodiments of the present disclosure and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a graph showing typical size ranges for primary and secondary fractures compared to the particle size distributions for microproppants and standard-sized, non-coke proppants;

FIG. 2 is a graph comparing the propped areas of an exemplary fracture using different types and combinations of proppants and microproppants; and

FIG. 3 is a graph showing a typical particle size distribution for flexicoke fines produced via a FLEXICOKING™ process;

FIG. 4 is a process flow diagram of an exemplary method of utilizing the fracturing fluid described herein during a hydraulic fracturing operation; and

FIG. 5 is a process flow diagram of an exemplary method of making the fracturing fluid described herein.

It should be noted that the figures are merely examples of the present disclosure and are not intended to impose limitations on the scope of the present disclosure. Further, the figures are generally not drawn to scale, but are drafted for purposes of convenience and clarity in illustrating various aspects and embodiments of the present disclosure.

### DETAILED DESCRIPTION

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or processes that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/of” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “apparent density,” with reference to the density of proppant particles, refers to the density of the individual particles themselves, which may be expressed in grams per cubic centimeter (g/cm³). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the term “blast furnace coke” refers to any coal-derived coke suitable for use in a blast furnace for making steel.

As used herein, the term “delayed coke” refers to the solid concentrated carbon material that is produced within delayed coking units via the delayed coking process. According to the delayed coking process, a preheated feedstock is introduced into a fractionator, where it undergoes a thermal cracking process in which long-chain hydrocarbons are split into shorter-chain hydrocarbons. The resulting lighter fractions are then removed as sidestream products. The fractionator bottoms, which include a recycle stream of heavy product, are heated in a furnace, which can have an outlet temperature of, e.g., around 895° F. to around 960° F. Exemplary outlet temperature ranges include around 900° F. to around 910° F., around 910° F. to around 920° F., around 920° F. to around 930° F., around 930° F. to around 940° F., around 940° F. to around 950° F., and around 950° F. to around 960° F., to name a few non-limiting examples. The heated feedstock then enters a reactor, referred to as a “coke drum,” which can operate at temperatures of, e.g., around 780° F. to around 840° F. Exemplary ranges of reactor temperature include around 780° F. to around 790° F., around 790° F. to around 800° F., around 800° F. to around 810° F., around 810° F. to around 820° F., around 820° F. to around 830° F., and around 830° F. to around 840° F., to name a few non-limiting examples. Within the coke drum, the cracking reactions continue. The resulting cracked products then exit the coke drum as an overhead stream, while coke deposits in the coke drum. In general, this process is continued for a period of around 16 hours to around 24 hours to allow the coke drum to fill with coke. Exemplary ranges of specific cracking process times include around 16 hours to around 18 hours, around 18 hours to around 20 hours, around 20 hours to around 22 hours, and around 22 hours to around 24 hours, to name a few non-limiting examples. In addition, to allow the delayed coking unit to operate on a batch-continuous (or semi-continuous) basis, two or more coke drums are used. While one coke drum is on-line filling with coke, another coke drum can be steam-stripped, cooled, decoked (e.g., via hydraulically cutting the deposited coke with water), pressure-checked, and warmed up. Moreover, the overhead stream exiting the coke drum enters the fractionator, where naphtha and heating oil fractions are recovered. The heavy recycle material is then typically combined with preheated fresh feedstock and recycled back into the process.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, the term “flexicoke” refers to the solid concentrated carbon material produced via the FLEXICOKING™ process, which is a thermal cracking process utilizing fluidized solids and gasification for the conversion of heavy, low-grade hydrocarbon feeds into lighter hydrocarbon products (e.g., upgraded, more valuable hydrocarbons). Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically about 496° C. to about 538° C. Exemplary ranges of reactor heat that may be used include around 496° C. to around 500° C., around 500° C. to around 510° C., around 510° C. to around 520° C., around 520° C. to around 530° C., around 530° C. to around 538° C., to name a few non-limiting examples. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

Relatedly, the terms “wet flexicoke fines” and “dry flexicoke fines” refer to two byproducts of the FLEXICOKING™ process. Such byproducts are collected as particles that were not recovered in the secondary cyclones of the heater. More specifically, the particles are collected first in the tertiary cyclone as dry flexicoke fines, and the smaller particles that travel past the tertiary cyclone are then recovered in the venturi scrubber as wet flexicoke fines.

As used herein, the term “fluid coke” refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. The fluid coking process differs from the Flexicoking™ process that produces the Flexicoke in that the fluid coking process does not include a gasifier.

The term “fracture” (or “hydraulic fracture”) refers to a crack or surface of breakage within a subterranean formation, that can be natural or induced by an applied pressure or stress. “Primary fracture” means a fracture or any segment of a fracture having a dimension capable of allowing a rigid ball having a diameter of 1 millimeter (mm) to pass through. “Secondary fracture” is a fracture or any segment of a fracture that is not a primary fracture.

As used herein, the term “metallurgical coke” refers to a type of coal-derived coke that is produced by heating coal, which causes fixed carbon to fuse to inherent ash and drives off a large percentage of the volatile matter. The resulting metallurgical coke particles include a range of different sizes, with the smallest particles being a fine powder (sometimes referred to as “coke breeze”).

The term “particle size(s),” when used herein with reference to a type of particles,” refers to the diameter(s) of such particle(s). The term “particle size distribution,” when used herein with reference to a type or a collection of particles, refers to the range of diameters for such particles, typically from the minimal to the maximal. The terms “average particle size distribution” and “D50” when used herein with reference to a type or a collection of particles, interchangeably mean the median particle size of the particles.

The term “petroleum coke” refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. As described herein, there are three main types of petroleum coke: delayed coke, fluid coke, and flexicoke. Each type of petroleum coke is produced using a different coking process; however, all three coking processes have the common objective of maximizing the yield of distillate products within a refinery by rejecting large quantities of carbon in the residue as coke.

The term “coal-derived coke” means any coke prepared from coal by, e.g., thermal treatment.

The term “preferentially,” when used herein with reference to the settling or deposition of a particular type of proppant within one or more particular regions of a subterranean formation, refers to the tendency of the proppant to settle or deposit in such region(s), but does not indicate that the proppant will only settle or deposit in such regions. In operation, it is expected that some amount of the proppant will settle or deposit within various regions of the subterranean formation. However, the characteristics of the proppant may render it more likely that such proppant will settle or deposit in the particular region(s) as compared to other types of proppant.

As used herein, the terms “proppant” and “proppant particle” refer to a solid material capable of maintaining open an induced fracture during and following a hydraulic fracturing treatment. The term “proppant pack” refers to a collection of proppant particles.

The terms “coke proppant” and “coke proppant particles” refer to a proppant based on or derived from a solid carbonaceous material produced from treating a carbon-containing material (e.g., oil (e.g., crude oil, vacuum pipestill, and the like), coal, and hydrocarbons) at an elevated temperature in an oxygen deficient environment. The elevated temperature can be at least 200, 250, 300, 350; 400, 450, 500, 600, 700, 800, 900, or even 1000° C. The carbonaceous material comprises the carbon element and optionally additional elements including but not limited to hydrogen, sulfur, vanadium, iron, and the like. The carbonaceous material preferably comprises the carbon element at a concentration of ≥50 wt %, e.g., from 50, 55, 60, 65, 70, wt %, to 75, 80, 85, 90, 95 wt %, to 96, 97, 98, 99 wt %, or even 100 wt %, based on the total weight of all elements in the carbonaceous material. The carbonaceous material preferably comprises the carbon element and hydrogen element at a combined concentration of ≥55 wt %, e.g., from 55, 60, 65, 70, wt %, to 75, 80, 85, 90, 95 wt %, to 96, 97, 98, 99 wt %, or even 100 wt %, based on the total weight of all elements in the carbonaceous material.

The term “non-coke proppant” means any proppant that does not comprise coke proppant particles. Examples of non-coke proppant include sand, ceramic proppants, glass proppants, and polymer proppants.

The term “lightweight proppant (LWP)” refers to proppants having an apparent density within a range of from around 1.2 g/cm³ to around 2.2 g/cm³ (e.g., from around 1.2, 1.3, 1.4, 1.5, 1.6 g/cm³ to around 1.7, 1.8, 1.9, 2.0, 2.1, 2.2 g/cm³), while the term “ultra-lightweight proppant (ULWP)” refers to proppants having an apparent density within a range from around 0.5 g/cm³ to around 1.2 g/cm³ (e.g., from around 0.5, 0.6, 0.7, 0.8 g/cm³ to around 0.9, 1.0, 1.1, 1.2 g/cm³). A coke proppant may or may not be an LWP. The term “non-LWP proppant” refers to proppants having apparent density higher than 2.2 g/cm³ (e.g., from around 2.3, 2.4, 2.5 to around 2.6, 2.8, 3.0, to 3.2, 3.4, 3.5 g/cm³.) A non-coke proppant may or may not be a non-LWP.

The term “microproppant coke particles” means a collection of coke proppant particles having particle sizes of at most 105 μm, but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm). The term “petroleum coke fines” means a collection of microproppant coke particles that are derived from a petroleum source material.

As used herein, the term “pyrolysis coke” refers to a type of coke that is generated via hydrocarbon pyrolysis at temperatures higher than the coking processes for making petroleum coke.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “substantially free” or “essentially free” when used with reference to a component of a composition, interchangeably means that the composition comprises the component at a concentration of ≤10 wt %, ≤5 wt %, ≤3 wt %, ≤1 wt %, or 0 wt %, based on the total weight of the composition, depending on the details of the particular implementation.

As used herein, the term “thermally post-treated coke” refers to petroleum coke that has been heated to temperatures in a range from around 400° C. to around 1200° C. for a predetermined duration that is in a range from around 1 minute to around 24 hours. Exemplary ranges of temperatures for heating thermally post-treated coke include around 400° C. to around 500° C., around 500° C. to around 600° C., around 600° C. to around 700° C., around 700° C. to around 800° C., around 800° C. to around 900° C., around 900° C. to around 1000° C., around 1000° C. to around 1100° C. and around 1100° C. to around 1200° C., to name a few non-limiting examples. Exemplary ranges of times for heating thermally post-treated coke include around 1 minute to around 1 hour, around 1 hour to around 2 hours, around 2 hours to around 4 hours, around 4 hours to around 8 hours, around 8 hours to around 12 hours, around 12 hours to around 16 hours, around 16 hours to around 20 hours and around 20 hours to around 24 hours, to name a few non-limiting examples.

The term “wellbore” refers to a borehole drilled into a subterranean formation. The borehole may include vertical, deviated, highly deviated, and/or horizontal sections. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Certain embodiments and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by a person having ordinary skill in the art.

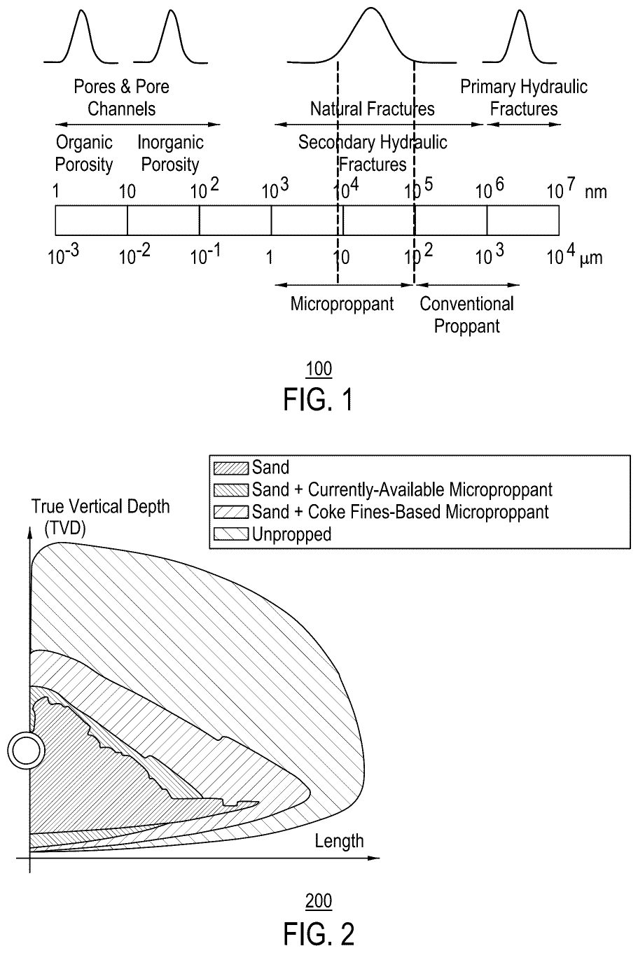

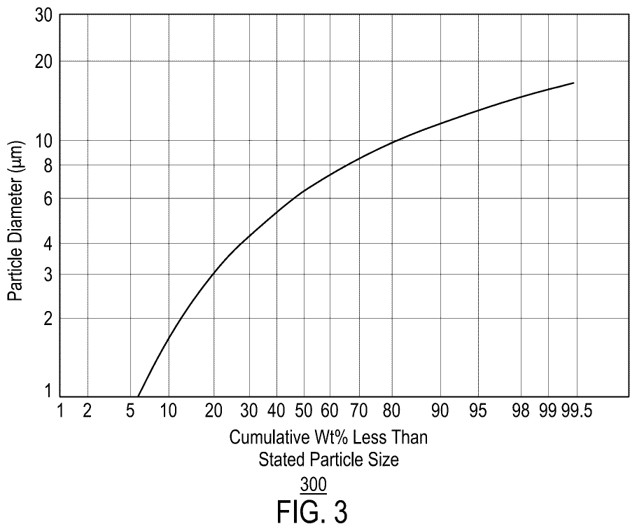

Turning now to details of the present disclosure, microproppants can be effectively utilized during hydrocarbon fracturing operations, resulting in production uplift for the corresponding hydrocarbon wells. Specifically, while standard-sized, non-coke proppants typically settle within the larger primary fractures of a subterranean formation, microproppants are particularly suited to travel into smaller secondary fractures. This is due, at least in part, to the relatively smaller particle sizes of microproppants. This is illustrated by FIG. 1, which is a graph 100 showing typical size ranges for primary and secondary fractures compared to the particle size distributions for microproppants and standard-sized, non-coke proppants. Specifically, as shown in FIG. 1, the size of the fracture apertures for secondary fractures typically range from less than 10 microns (m) to greater than 100 km, while the particle sizes of standard-sized, non-coke proppants are typically greater than 100 μm. This generally prevents standard-sized, non-coke proppants from transporting into secondary fractures with smaller fracture apertures. This is due, at least in part, to the fact that the fracture aperture must be larger than the proppant size to prevent bridging effects. For example, lab-scale experiments have shown that a natural fracture (or secondary fracture) with a fracture aperture of 450 μm will not allow the pass-through of proppants with particle sizes exceeding 64 μm. A summary of this lab-scale study is provided in Table 1, which compares the size of the fracture aperture to the maximum proppant sizes that will prevent bridging (or clogging) and allow pass-through of the particles, respectively. In other words, looking at Table 1, for a 450-μm fracture aperture, proppant sizes of at most 149 μm (or 100 mesh) are unlikely to cause bridging effects, while proppant sizes of at most 64 μm (or 230 mesh) are likely to pass through the fracture aperture.

Based on Table 1, it is clear that microproppants are much more well-suited for propping secondary fractures as compared to standard-sized, non-coke proppants. As a result, microproppants can be used to effectively extend the stimulated reservoir volume (SRV) by increasing the total propped area in the subterranean formation.

TABLE 1

| | |
|---|---|
| Fracture | Maximum Proppant Size for |

| Aperture | Preventing Bridging | Allowing Pass-Through |
|---|---|---|
| (μm) | (μm/mesh) | (μm/mesh) |
| 450 | 149/100 | 64/230 |
| 400 | 133/110 | 57/270 |
| 350 | 117/130 | 50/300 |
| 300 | 100/140 | 43/325 |
| 250 | 83/170 | 36/400 |
| 200 | 67/230 | 28/550 |
| 150 | 50/270 | 21/625 |
| 100 | 33/400 | 14/1083 |
| 50 | 17/812 | 7.1/1975 |
| 25 | 8/1750 | 3.6/3900 |
| 10 | 3/4500 | 1.4/10133 |

In addition, microproppants exhibit enhanced transport properties as compared to non-coke proppants. Specifically, based on Stoke's law, the rate of settling of a proppant particle (i.e., the setting velocity, denoted as νt) is a function of the density (ρ_{f}) of the carrier fluid, the density (ρₚ) of the proppant particle, and the particle size/diameter (Dₚ) of the proppant particle, as given by Equation 1:

$$v t = \frac{g}{18} \times ( \frac{1}{μ f} ) \times {D}_{p}^{2} \times ( {ρ}_{p} - {ρ}_{f} ) \qquad Equation 1$$

where g is the gravitational constant and pf is the viscosity of the carrier fluid. Moreover, particle size has a significant impact factor as it is a squared function. Reduced particle size can lead to larger reductions in settling velocity, therefore leading to the proppant particles being carried further into the primary and secondary fractures.

A hydraulic fracturing job at a given stage typically comprises two phases: the pad phase and the slurry phase after the pad phase. In the pad phase, a high-pressure fracturing fluid conventionally without containing proppants or, in rare cases, where non-coke microproppants are utilized, containing a relatively small loading of non-coke microproppants, is injected into the formation through the wellbore to break down the formation and create a “pad” comprising some initial fractures. During the slurry phase, a high-pressure proppant-containing fracturing fluid is additionally injected into the pad and initial fractures created in the pad phase, whereby more fractures are created and proppant particles are distributed in fractures. Typical hydraulic fracturing applications for currently-available non-coke microproppant include injecting around 5,000 to around 15,000 pounds of microproppant per stage during the pad phase only. The theory behind this pumping strategy is to allow the microproppant to be pumped ahead of non-coke proppants such that the microproppant coke particles settle within the secondary fractures before the smaller fracture apertures are blocked by the settling of the non-coke proppant within the corresponding primary fracture(s).

Furthermore, the utilization of microproppants can beneficially reduce the pressure dependent leak-off of the fracturing fluid into the surrounding formation. This, in turn, enables lower treatment pressures, higher pump rates, and reduced pump times for the overall treatment. Moreover, while it is not unusual for high pressures within difficult-to-treat formations to limit the total pumped proppant volume to around 20% or less of the designed amount, the utilization of microproppant may enable the designed proppant volume to be fully pumped into difficult-to-treat formations, thus further increasing the effectiveness of the hydraulic fracturing operation.

However, despite the benefits of utilizing microproppants for hydraulic fracturing operations, the relatively high cost of currently-available microproppants has imposed a practical limitation on the volume of microproppant that is utilized for each hydrocarbon well. In particular, as described above, non-coke microproppant injection involving commercially available microproppants free of coke particles is typically limited to around 5,000 to around 15,000 pounds of microproppant per stage during the pad phase only, with it being generally cost-prohibitive to explore injecting those microproppant throughout the remainder of the treatment (i.e., after the pad phase is complete). With such injection of the microproppant during the pad phase only, however, there is no realistic expectation that the microproppant coke particles will travel deep into the subterranean formation since the first 600 to 1,000 barrels (95.4 to 159.0 cubic meters) of fracturing fluid injected during the pad phase will generally not reach the fracture tip. As a result, according to current strategies utilizing currently-available non-coke microproppant, the microproppant coke particles only prop the first few hundred feet of the fracture half-length (at best).

The present disclosure alleviates the foregoing difficulty and provide related advantages as well. In particular, the present disclosure provides microproppant coke particles formed from (e.g., comprising, consisting essentially of, or consisting of) petroleum coke fines and/or other coke materials with particle sizes of at most 105 μm. Such microproppant coke particles are provided within a fracturing fluid at a concentration of at least 3 wt % (e.g., from 3, 4, 5, 6, 7, 8, 9, 10 wt % to 15, 20, 25, 30, 35, 40, 45, 50 wt %, to 55, 60, 65, 70, 75, 80, 85 wt %, to 90, 91, 92, 93, 94, 95, 96, 97, 98, 99, 100 wt %) based on the total weight of coke particles in the fracturing fluid (where the weight percent of the particles may be determined prior to mixing the particles with the carrier fluid, e.g., on a dry particles basis). The coke particles are desirably dispersed in a carrier fluid. Moreover, such fracturing fluid may be introduced into a subterranean formation during a hydraulic fracturing operation within a horizontal, vertical, or tortuous wellbore, including hydrocarbon-bearing production wellbores and/or water-bearing production wellbores. The introduction of such microproppant coke particles into the subterranean formation enables the effective propping of extended regions of the primary and secondary fractures in the subterranean formation.

The fracturing fluid of this disclosure may comprise, in addition to microproppant coke particles, a second portion of coke particles with sizes larger than 105 μm. In general, the total concentration of coke particles in the fracturing fluid is at least 14 kilograms (kg) of coke particles per cubic meter (m³) of the carrier fluid, and can range from, e.g., 14, 15, 16, 17, 18, 19, 20 kg·m⁻³, to 21, 22, 23, 24, 25, 26, 27, 28, 29, 30 kg·m⁻³, to 35, 40, 45, 50, 55, 60, 65, 70 kg·m⁻³, to 80, 90, 95, 96, 100, 150, 160, 180, 200 kg·m⁻³, to 220, 240, 250, 260, 280, 300 kg·m^{31 3}, to 350, 400, 450, 480 kg·m^{31 3}, based on the volume of the carrier fluid. A concentration range from 18 to 120 kg·m⁻³ is highly desirable. A preferable concentration range is from 23 to 96 kg·m⁻³. At a total coke particle concentration in the fracturing fluid below 14 kg·m^{31 3}, the amount of coke particles introduced into the subterranean formation is too low to function as an effective proppant at a given, reasonable volume of carrier fluid; or alternatively, if a reasonable amount of coke particles were to be introduced into the subterranean formation, an infeasibly large volume of the carrier fluid would have to be injected. Either case would be highly undesirable. At a coke particle concentration in the fracturing fluid at above 480 kg·m⁻³, the cost of the coke particles can be too high to justify additional benefit of the higher amount, if any at all.

Thus, in the fracturing fluid of this disclosure, where all of the coke particles present are microproppant coke particles, the concentration of the microproppant coke particles in weight relative to the volume of carrier fluid therein can range from, e.g., 14 to 480 kg·m^{31 3}, preferably from 18 to 120 kg·m^{31 3}, and more preferably from 23 to 96 kg·m⁻³. Where the concentration of the microproppant coke particles is x wt % of the total weight of all coke particles present in the fracturing fluid, the concentration of the microproppant coke particles in weight relative to the volume of the carrier fluid therein can range from, e.g., 14*x % to 480*x % kg·m⁻³, preferably from 18*x % to 120*x % kg·m^{31 3}, and more preferably from 23*x % to 96*x % kg·m⁻³.

While without intending to be bound by a particular theory, it is believed that in many modern unconventional hydrocarbon recovery processes involving horizontal drilling and hydraulic fracturing, the hydrocarbon-bearing subterranean formations tend to have very low permeability, rendering fluid loss due to the presence of natural cracks not a significant issue. As such, the coke particles in the fracturing fluid of this disclosure function essentially as proppants instead of fluid loss preventers, by maintaining induced cracks open (“propped”) after pressure relief following hydraulic fracturing, allowing hydrocarbon to migrate from the formation through the induced cracks into the wellbore during hydrocarbon production. The coke particles, in general and regardless of particle size, due to their low apparent density, tend to stay dispersed in the carrier fluid for a longer time instead of settling out, enabling them to be transported further into distant crack locations than heavy proppant particles such as sand and commercially available microproppant particles based on ceramic materials, to maintain longer and more cracks open, thereby enhancing hydrocarbon recovery. Additionally, the microproppant coke particles, due to their small sizes, can stay in the carrier fluid even longer than the coke particles having a size greater than 105 μm, enter into even more distant cracks from the wellbore and cracks with sizes smaller than 105 μm near or distant from the wellbore, keep those cracks open, and significantly improve hydrocarbon recovery during production.

In some embodiments (pad-phase-only embodiments), the fracturing fluid including the microproppant coke particles is injected into the subterranean formation during only the pad phase of the hydraulic fracturing operation, prior to the injection of another fracturing fluid including one or more other types of proppant particles, such as non-coke proppants (e.g., sand), LWP, and/or ULWP. In some embodiments, during the pad phase, the fracturing fluid comprise no other proppant particles than the microproppant coke particles. In some embodiments, during the pad phase, the fracturing fluid may comprise, in addition to the microproppant coke particles, other microproppant particles such as: glass microproppants, ceramic microproppants, polymer microproppants, sand microproppants, and combinations thereof. In such embodiments, the microproppant coke particles can be present at a concentration of, e.g., from 10, 20, 30, 40, 50 wt %, to 60, 70, 80, 90, 95, 98 wt %, based on the total weight of all microproppant particles in the fracturing fluid. Without intending to be bound by a particular theory, it is believed that due to the low density and small sizes of the microproppant coke particles, they can be conveniently transported into a substantial portion (e.g., ≥50%, ≥60%, ≥70%, ≥80%, ≥90%, ≥95%) of the initial cracks created during the pad phase, more so than the commercially available microproppants based on ceramic materials. Subsequently, during the slurry phase, the microproppant coke particles already present in the initial cracks can be further transported into additional cracks, especially secondary cracks, created during the slurry phase, and maintain them propped after the pressure is reduced, enabling more production of hydrocarbon products through more propped cracks during the production phase of the well. Thus, by including microproppant coke particles in the fracturing fluid during the pad phase, it may become unnecessary to further include microproppant particles in the fracturing fluid during the subsequent slurry phase. During the pad phase, while it is possible to include non-microproppant proppant particles such as coke particles having sizes greater than 105 μm, it is preferred that, based on the total weight of the proppant particles present in the fracturing fluid, ≥50 wt %, ≥60 wt %, ≥75 wt %, ≥80 wt %, ≥90 wt %, ≥95 wt %, or even 100 wt % of the proppant particles present in the fracturing fluid are microproppant particles. Large size proppant particles such as those having a size larger than 105 μm, if used at large quantity, can result in screening out of some of the initial cracks created during the pad phase, thereby reducing the efficacy of the fracturing operation during the pad phase and the subsequent slurry phase.

In some other embodiments (slurry-phase-only embodiments), the fracturing fluid including the microproppant coke particles is injected into the subterranean formation only in the slurry phase and not in the pad phase. In such slurry-phase-only embodiments, the fracturing fluid used during the pad phase may be free of any proppant or may comprise non-coke microproppant particles. In some such embodiments, during the slurry phase, the fracturing fluid comprise no other proppant particles other than the microproppant coke particles. In some embodiments, during the slurry phase, the fracturing fluid may comprise, in addition to the microproppant coke particles, other proppant particles such as: non-coke microproppant particles; coke proppant particles having size larger than 105 μm; non-coke proppant particles having sizes greater than 105 μm; and combinations thereof. In such embodiments, the microproppant coke particles can be present at a concentration of, e.g., from 3, 4, 5, 6, 7, 8, 9, 10 wt %, to 20, 30, 40, 50 wt %, to 60, 70, 80, 90, 95, 98, 100 wt %, based on the total weight of all coke particles in the fracturing fluid. In such embodiments, the microproppant coke particles can be present at a concentration of, e.g., from 3, 4, 5, 6, 7, 8, 9, 10 wt %, to 20, 30, 40, 50 wt %, to 60, 70, 80, 90, 95, 98, 100 wt %, based on the total weight of all proppant particles in the fracturing fluid. Where the fracturing fluid comprises both microproppant coke particles and other types of proppant particles, the microproppant coke particles may be transported together with other types of proppant particles into primary fractures and settle there at various amounts. However, the properties (e.g., the low density and smaller sizes) of the microproppant coke particles enable at least a portion of such microproppant coke particles to self-segregate from the other type(s) of proppant particles in the subterranean formation, thus enabling the other type(s) of proppant particles to preferentially settle within the primary fracture(s) while the microproppant coke particles travel further into the formation and preferentially settle within the secondary fractures. In this manner, the microproppant coke particles described herein serve to increase the stimulated reservoir volume (SRV) for the corresponding formation by propping extended fracture regions that cannot be reached using other types of proppant particles such as coke particles having sizes greater than 105 μm, sand, and commercially available microproppant particles based on ceramic materials.

In still other embodiments (dual-phase embodiments), the fracturing fluid comprising microproppant coke particles may be injected into the subterranean formation both during the pad phase, in manners substantially the same as described above in connection with the pad-phase-only embodiments, and during the slurry phase, in manner substantially the same described above in connection with the slurry-phase-only embodiments. The use of microproppant coke particles in the fracturing fluid during both pad and slurry phases may enable more microproppant coke particles to be transported into more secondary cracks and cracks at longer distances from the wellbore.

FIG. 2 is a graph 200 comparing propped areas of an exemplary fracture using different types and combinations of proppants and microproppants. Specifically, as shown in FIG. 2, when a fracturing fluid including only sand as the proppant is injected into the fracture, the sand particles settle quickly within the near-wellbore region of the fracture due, at least in part, to the relatively large particle sizes and high densities of the sand particles. When a fracturing fluid including a combination of sand and currently-available non-coke microproppant is injected into the fracture, the microproppant particles travel further than sand into the fracture due to the relatively small particle sizes of the microproppant non-coke particles. Notably, however, when a fracturing fluid including a combination of sand and the microproppant coke particles described herein is injected into the fracture, the microproppant coke particles, which have smaller particle sizes and significantly lower density, can be transported much further than the currently-available non-coke microproppants within the fracture and settle, at least in part, within remote regions of the primary fracture and secondary fractures beyond the reach of currently available non-coke microproppants. Accordingly, a larger total propped area can be achieved by injecting fracturing fluid including the microproppant coke particles described herein than injecting fracturing fluid including commercially available microproppant, resulting in increased stimulated reservoir volume (“SRV”) of the well.

According to embodiments described herein, the microproppant coke particles may include (e.g., comprise, consist essentially of, or consist of) wet flexicoke fines and/or dry flexicoke fines produced as a byproduct of the FLEXICOKING™ process. Additionally or alternatively, the microproppant coke particles may include (e.g., comprise, consist essentially of, or consist of) sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). Additionally or alternatively, the microproppant coke particles may include (e.g., comprise, consist essentially of, or consist of) ground fluid coke, ground flexicoke, ground delayed coke, ground thermally post-treated coke, ground pyrolysis coke, and/or ground coal-derived coke (e.g., ground blast furnace coke and/or ground metallurgical coke). Moreover, any other suitable types of coke may be additionally or alternatively utilized. Such coke may be sieved, ground, crushed, pulverized, and/or otherwise treated to produce coke fines that are suitably sized to be characterized as the microproppant coke particles described herein.

In some embodiments, the microproppant coke particles included in the fracturing fluid can comprise, consist essentially of, or consist of wet and/or dry flexicoke fines. Such flexicoke fines are byproducts of the FLEXICOKING™ process, which are collected as particles that were not recovered in the secondary cyclones of the heater within the flexicoker. More specifically, the particles are collected first in the tertiary cyclone as dry flexicoke fines, and the smaller particles that travel past the tertiary cyclone are then recovered in the venturi scrubber as wet flexicoke fines. While at least a portion of such wet flexicoke fines and dry flexicoke fines would typically be considered as waste according to current techniques, the present disclosure provides for the effective utilization of such wet flexicoke fines and dry flexicoke fines during hydraulic fracturing operations.

The petroleum coke fines that may be utilized as microproppant coke particles according to embodiments described herein may have an average particle size distribution in a range from 10 μm to 27 μm. Moreover, in some embodiments, the average particle size distribution for the petroleum coke fines is in a range from around 14 μm to around 23 μm. In other embodiments, exemplary ranges of average particle size distribution for petroleum coke fines include around 10 μm to around 12 μm, around 12 μm to around 14 μm, around 14 μm to around 16 μm, around 16 m to around 18 μm, around 18 μm to around 20 μm and around 20 μm to around 23 μm. As an example, for embodiments in which wet flexicoke fines are utilized as microproppant coke particles, such particles may have a D50 of around 22 μm (meaning that 50% of the particles are smaller than around 22 μm), a D10 of around 5 μm (meaning that 10% of the particles are smaller than around 5 μm), and a D90 of around 112 μm (meaning that 90% of the particles are smaller than around 112 μm). As another example, for embodiments in which dry flexicoke fines are utilized as microproppant coke particles, such particles may have a D50 of around 15 μm (meaning that 50% of the particles are smaller than around 15 m), a D10 of around 6 μm (meaning that 10% of the particles are smaller than around 6 m), and a D90 of around 94 μm (meaning that 90% of the particles are smaller than around 94 m). Stated more generally, the wet flexicoke fines may have a mean particle size that is in a range from 20 μm to 24 μm, while the dry flexicoke fines may have a mean particle size that is in a range from 13 μm to 17 μm.

In various embodiments, the microproppant coke particles described herein have an apparent density that is in a range from 1.0 g/cm³ to 2.0 g/cm³ or, in some embodiments, a range from around 1.4 g/cm³ to around 1.7 g/cm³, although the exact apparent density of the particles may vary depending on the specific type(s) of coke utilized. In various embodiments, the average apparent density for the microproppant coke particles is around 1.6 g/cm³. Other exemplary ranges of microproppant coke particle apparent density include around 1.0 g/cm³ to around 1.2 g/cm³, around 1.2 g/cm³ to around 1.4 g/cm³, around 1.4 g/cm³ to around 1.6 g/cm³, around 1.6 g/cm³ to around 1.8 g/cm³, around 1.8 g/cm³ to around 2.0 g/cm³, around 1.0 g/cm³ to around 1.4 g/cm³, around 1.4 g/cm³ to around 1.8 g/cm³, around 1.0 g/cm³ to around 1.5 g/cm³, and around 1.5 g/cm³ to around 2.0 g/cm³, to give a few non-limiting examples. By comparison, sand generally has an apparent density of around 2.5 g/cm³ or higher. Therefore, because the settling rate is proportional to the difference in density between the solid particles and the carrier fluid (as shown in expressions for both Stokes terminal settling velocity and Ferguson & Church settling velocity), the microproppant coke particles described herein have a significantly lower settling rate than sand. As a result, the microproppant coke particles described herein will perform better than proppant particles formed from sand in terms of transport capacity within the fractures created during a hydraulic fracturing operation.

In various embodiments, the microproppant coke particles described herein are used as part of a fracturing fluid. In addition to the microproppant coke particles described herein, the fracturing fluid includes a flowable carrier fluid, (optionally) one or more additives, (optionally) other coke particles that are not suitably sized to be characterized as the microproppant coke particles, and (optionally) one or more other types of proppant particles. The other coke particles that are not suitably sized to be characterized as the microproppant coke particles (which are sometimes referred to herein interchangeably as “second coke particles” or a “second portion” of the coke particles within the fracturing fluid) may include, but are not limited to, fluid coke particles, flexicoke particles, delayed coke particles, thermally post-treated coke particles, pyrolysis coke particles, and/or coal-derived coke particles (e.g., blast furnace coke particles and/or metallurgical coke particles). Such second coke particles may have particle sizes of greater than 105 μm.

The one or more other types of proppant particles (which are sometimes referred to herein as “third proppant particles” or “non-coke particles”) may include, but are not limited to, non-coke proppant particles (such as 100-mesh sand), LWP particles, ULWP particles, and/or any other suitable types of commercially-available proppant particles that differ from the coke particles. Moreover, according to embodiments described herein, the microproppant coke particles are designed to preferentially settle at least in part within the secondary fractures in the subterranean formation (in addition to the primary fracture(s) in the subterranean formation), while the second coke particles and the third proppant particles are designed to preferentially settle within the primary fracture(s) in the subterranean formation.

In various embodiments, the fracturing fluid is formulated at the well site in a mixing process that is conducted concurrently with the pumping of the fracturing fluid into the wellbore during the hydraulic fracturing process. When the fracturing fluid is formulated at the well site, the microproppant coke particles may be added in a manner similar to known methods for adding proppant to fracturing fluid.

The carrier fluid according to the present techniques may be an aqueous carrier that includes water or a non-aqueous carrier fluid that is substantially free of water. Aqueous carrier fluids may include, for example, fresh water, salt water (including seawater), treated water (e.g., treated production water), one or more other forms of aqueous fluid, or any combination thereof. One aqueous carrier fluid class is often referred to as slickwater, and the corresponding fracturing operations are often referred to as slickwater fracturing operations. Non-aqueous carrier fluids may include, for example, oil-based fluids (e.g., hydrocarbon, olefin, mineral oil), alcohol-based fluids (e.g., methanol), or any combination thereof. In various embodiments, the viscosity of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers.

In some instances, the carrier fluid used in hydraulic fracturing of horizontal wells includes one or more aqueous carrier fluid types, particularly in light of the large volumes of fluid typically required for hydraulic fracturing (e.g., about 60,000 to about 1,000,000 gallons per wellbore). The aqueous carrier fluid may or may not be gelled. The utilization of gelled aqueous carrier fluids (either crosslinked or un-crosslinked) may facilitate better proppant particle transport (i.e., reduce settling), as well as provide improved physical and chemical strength to withstand the temperatures, pressures, and shear stresses encountered by the fracturing fluid during a hydraulic fracturing operation. In some instances, the fracturing fluid includes an aqueous carrier fluid, which may or may not be foamed or gelled, and an acid (e.g., HCl) to further stimulate and enlarge pore areas of the matrix of fracture surfaces. It is to be appreciated that the low density of the microproppant coke particles described herein may allow a reduction or elimination of the need to foam or gel the carrier fluid. In addition, certain fracturing fluids suitable for use according to embodiments described herein may contain one or more additives. Such additives may include, but are not limited to, one or more acids, one or more biocides, one or more breakers, one or more corrosion inhibitors, one or more crosslinkers, one or more friction reducers (e.g., polyacrylamides), one or more gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, one or more clay stabilizing agents, or any combination thereof.

In some embodiments, additionally or alternatively to the conventional types of carrier fluids described above, the carrier fluid is liquid carbon dioxide (CO₂) and/or supercritical CO₂. While fracturing fluids including liquid and/or supercritical CO₂ are capable of creating complex fracture networks within a subterranean formation, the utilization of CO₂ for hydraulic fracturing operations has been limited due to CO₂'s poor ability to effectively transport proppant for long distances. However, the microproppant coke particles described herein are particularly suited for effective transportation within CO₂-based carrier fluid due to the relatively small particle sizes of the microproppant coke particles. Accordingly, in some embodiments, the method described herein includes utilizing liquid and/or supercritical CO₂ as at least a portion of the carrier fluid for the fracturing fluid described herein during at least a portion of the hydraulic fracturing operations for an unconventional reservoir.

The present disclosure provides methods for hydraulically fracturing a subterranean formation using a fracturing fluid including the microproppant coke particles described herein. Such microproppant coke particles may optionally be used in combination with other coke particles that are not suitably sized to be characterized as microproppant coke particles (i.e., the second coke particles described above) and/or one or more types of non-coke particles (i.e., the third proppant particles described above). Therefore, the microproppant coke particles may form either the entirety of a proppant pack or an integral part of a proppant pack, depending on the details of the particular implementation.

Moreover, additionally or alternatively to the second coke particles and the third proppant particles described herein, one or more other types of proppant particles including other materials may be included in the fracturing fluid described herein along with the microproppant coke particles, provided that any such selected proppant particles are able to maintain their integrity upon removal of hydraulic pressure within an induced fracture, such that about 80%, preferably about 90%, and more preferably about 95% or greater of the particle mass of the other proppant particles retains integrity when subjected to 5000 psi of stress, a condition also met by the microproppant coke particles described herein. That is, both the microproppant coke particles and any other type(s) of proppant particles used according to the methods described herein maintain mechanical integrity upon fracture closure, as both types of particles (at least partially) intermingle or otherwise associate to form functional proppant packs for a successful hydraulic fracturing operation.

The methods described herein include preparation of the fracturing fluid, which is not considered to be particularly limited, because the microproppant coke particles are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the microproppant coke particles may be added to the carrier fluid, including the optional additives, at a production site, either directly into a wellbore or by pre-mixing in a hopper or other mixing equipment. For example, in some embodiments, slugs of the dry or wet form of the microproppant coke particles (or some combination of the microproppant coke particles and other coke particles) may be added directly to the fracturing fluid (e.g., as it is introduced into the wellbore). In other embodiments, such as when other type(s) of proppant particles (e.g., the second coke particles and/or the third proppant particles) are combined with the microproppant coke particles, a portion or all of the fracturing fluid may be pre-mixed at the production site, or each proppant type may be added directly to the fracturing fluid separately. Any other suitable mixing or adding of the microproppant coke particles to produce a desired fracturing fluid composition may also be used, without departing from the scope of the present disclosure.

The methods of hydraulic fracturing suitable according to embodiments described herein involve pumping fracturing fluid including the microproppant coke particles at a high pump rate into a subterranean formation to form one or more primary fracture and one or more secondary fractures extending from the primary fracture. In a preferred embodiment, this process is conducted one stage at a time along a wellbore. The stage is hydraulically isolated from any other stages that have been previously fractured. In some embodiments, the stage being fractured has clusters of perforations that allow the flow of fracturing fluid through a metal tubular casing of the wellbore into the formation. Such metal tubular casings are installed as part of the completions when the wellbore is drilled and serve to provide mechanical integrity for the wellbore. In some embodiments, the pump rate of the fracturing fluid during the hydraulic fracturing operation is at least about 20 barrels per minute (bbl/min) (0.05 cubic meters per second (m³/s)), preferably about 30 bbl/min (0.08 m³/s), and more preferably at least 50 bbl/min (0.14 m³/s) and at most 1000 bbl/min (2.73 m³/s) at one or more time durations during the hydraulic fracturing operation (e.g., the rate may be constant, steadily increased, or pulsed). These high rates may, in some embodiments, be utilized after about 10% of the entire volume of fracturing fluid to be pumped into the formation has been injected. That is, at the early periods of the hydraulic fracturing operation, the pump rate may be lower and as fractures begin to form, the pump rate may be increased. Generally, the average pump rate of the fracturing fluid throughout the operation may be about 10 bbl/min (0.03 m³/s), preferably about 15 bbl/min (0.04 m³/s), and more preferably at least 25 bbl/min (0.07 m³/s) and at most 250 bbl/min (0.68 m³/s). Typically, the pump rate of the fracturing fluid during a fracturing operation for more than 30% of the time required to complete fracturing of a stage is in the range of about 20 bbl/min (0.05 m³/s) to about 150 bbl/min (0.41 m³/s) (e.g., 20, 60, 90 bbl/min, to 120, 150 bbl/min), or about 40 bbl/min (0.11 m³/s) to about 120 bbl/min (0.33 m³/s) (e.g., 40, 50, 60, 90 bbl/min to 100, 100, 120 bbl/min), or about 40 bbl/min (0.11 m³/s) to about 100 bbl/min (0.27 m³/s) (e.g., 40, 50, 60 bbl/min to 80, 90 100 bbl/min).

In various embodiments, the methods of hydraulic fracturing described herein are performed such that the concentration of the microproppant coke particles, as well as the concentration(s) of the optional second coke particles and/or the optional third proppant particles, within the injected fracturing fluid are altered on-the-fly while the fracturing operation is being performed, such that the hydraulic pressure is maintained within the formation and the fracture(s). For example, in some embodiments, the initially-injected fracturing fluid is injected at a low pump rate and includes about 1 weight percent (wt %) proppant particles (i.e., including the microproppant coke particles, the optional other coke particles, and the optional one or more other types of proppant particles) based on the total weight of the fracturing fluid (i.e., including the carrier fluid). As one or more fractures begin to form and grow, the pump rate may be increased and the concentration of the proppant particles may be increased in a stepwise fashion (with or without a stepwise increase in pump rate), with a maximum concentration of total proppant particles reaching about 2.5 wt % to about 20 wt %, for example, based on the total weight of the fracturing fluid. For example, the maximum concentration of total proppant particles may reach at least 2.5 wt %, preferably about 8 wt %, and more preferably about 16 wt %. In some embodiments, all of the proppant particles are coke particles, including both microproppant coke particles and second coke particles, if any second coke particles are present. In other embodiments, at one or more time periods during the hydraulic fracturing operation, at least about 2 wt % to about 100 wt % of any proppant particles suspended within the fracturing fluid are coke particles, such as at least about 2 wt %, preferably about 15 wt %, more preferably about 25 wt %, and even more preferably 100 wt %. Other exemplary values for coke particles suspended within the fracturing fluid include around 10 wt %, around 20 wt %, around 30 wt %, around 40 wt %, around 50 wt %, around 60 wt %, around 70 wt %, around 80 wt % and around 90 wt %.

In various embodiments, the microproppant coke particles are introduced into the subterranean formation during at least a portion of the pad phase of the fracturing operation to allow the microproppant coke particles to travel with the fracturing fluid into the tips (or at least within proximity to the tips) of the formed primary and secondary fractures. In such embodiments, the microproppant coke particles may also be introduced into the formation during at least a portion of the later phases of the fracturing operation such that the later-introduced slurry of fracturing fluid and microproppant coke particles (optionally in combination with second coke particles and/or third proppant particles) continue to displace the earlier-introduced slurry of fracturing fluid and microproppant coke particles further away from the wellbore. Moreover, in some embodiments, the microproppant coke particles are introduced into the formation throughout the fracturing operation, either continuously or intermittently. In such embodiments, the ratio of microproppant coke particles to second coke particles, the ratio of microproppant coke particles to third proppant particles, and/or the ratio of microproppant coke particles to both second coke particles and third proppant particles may optionally be maintained at a steady (or substantially steady) value.

The hydraulic fracturing methods described herein may be performed in drilled horizontal, vertical, or tortuous wellbores, including hydrocarbon-producing (e.g., oil and/or gas) wellbores and/or water-producing wellbores. Such wellbores may be drilled into various types of formations, including, but not limited to, shale formations, oil sand formations, gas sand formations, and the like.

The wellbores are typically completed using a metal (e.g., steel) tubular or casing that is cemented into the subterranean formation. To contact the formation, a number of perforations can be created through the tubular and cement along a section to be treated, usually referred to as a plug and perforated (“plug-and-perf”) cased-hole completion. Alternative completion techniques may be used without departing from the scope of the present disclosure, but in each completion technique, a finite length of the wellbore is exposed for hydraulic fracturing and injection of fracturing fluid. This finite section is referred to herein as a “stage.” Full completion of a horizontal well typically includes hydraulic fracturing of multiple stages performed sequentially. In plug-and-perf completions, the stage length may be based on a distance over which the tubular and cement has been perforated, and may be in the range of about 10 feet (ft) (3 meters (m)) to about 2000 ft (610 m), for example, and more generally in the range of about 100 ft (30.5 m) to about 300 ft (91.4 m). The stage is isolated (e.g., using a sliding sleeve or frac plug and ball) such that pressurized fracturing fluid from the surface can flow through the perforations and into the formation to generate one or more fractures in only the stage area. Clusters of perforations may be used to facilitate initiation of multiple fractures. For example, clusters of perforations may be made in sections of the stage that are about 1 ft (0.3 m) to about 3 ft (0.9 m) in length and spaced apart by about 10 ft (3 m) to about 50 ft (15.2 m).

For each linear foot of a stage, at least about 6 barrels (0.95 cubic meters (m³)), preferably about 24 barrels (3.8 m³), and more preferably at least 60 barrels (9.5 m³) and at most 6000 barrels (953.9 m³) of fracturing fluid may be injected to grow the fractures. In certain embodiments, for each linear foot of a stage, at least about 0.05 m³, preferably at least about 0.18 m³, and more preferably at least 0.45 m³ and at most 45.3 m³, or at most 22.7 m³, or at most 18.1 m³, of proppant particles (i.e., including the microproppant coke particles, optional second coke particles, and optional third proppant particles) may be injected to prop the fractures.

Certain commercial operations, such as commercial shale fracturing operations, may be particularly suitable for hydraulic fracturing using the microproppant coke particles described herein, as the mass of total proppant particles required per stage in such operations can be quite large and substantial economic benefit may be derived by using the microproppant coke particles described herein to prop extended regions of the fractures. The cost of coke particles can be less than the cost of sand and is substantially less than the cost of currently-available microproppants, which provides a significant economic benefit. Indeed, in some instances, a stage in a shale formation may be designed to require at least about 30,000, preferably at least about 100,000, and more preferably at least about 250,000 pounds (mass) of total proppant particles. In such cases, economic and performance benefit may be optimized when at least 3 wt % (e.g., in some embodiments, 5 wt % to 100 wt %, 10 wt % to 90 wt %, 30 wt % to 80 wt %, 40 wt % to 70 wt %, or 50 wt % to 60 wt %) of the total weight of coke particles in the fracturing fluid includes the microproppant coke particles described herein. For example, for embodiments in which the microproppant coke particles described herein are included within the fracturing fluid during the pad phase, about 200 pounds to about 15,000 pounds, or about 500 pounds to about 10,000 pounds, or about 1,000 pounds to about 7,500 pounds, or about 2,000 pounds to 50,000 pounds of the microproppant coke particles may be included within the fracturing fluid during the pad phase for each stage, depending on, in part, the concentration of the microproppant coke particles as compared to the total weight of coke particles (or, in some cases, the total weight of all proppant particles) in the fracturing fluid (with 3 wt %, 33 wt %, and 100 wt %, respectively, being used as representative concentration values in this example). However, for the slurry-phase-only embodiments and dual-phase embodiments in which the microproppant coke particles described herein are included within the fracturing fluid during the slurry phase, from about 900, 1000, 2000, 3000, 4000, 5000 pounds, to about 7000, 7500, 8000, 8500, 9000, 10,000 pounds, to about 20,000, 40,000, 50,000, 60,000, 80,000, 90,000, 100,000 pounds, to about 120,000, 150,000, 180,000, 200, 000, 220,000, 240,000, 250,000 pounds, of the microproppant coke particles may be included within the fracturing fluid during the hydraulic fracturing of each stage, depending on, in part, the concentration of the microproppant coke particles as compared to the total weight of coke particles (or, in some cases, the total weight of all proppant particles) within the fracturing fluid (with 3 wt %, 33 wt %, and 100 wt %, respectively, being used as representative concentration values in this example). Moreover, as described herein, the utilization of such a large amount of the microproppant coke particles described herein is economically feasible due to the relatively low cost of such coke particles as compared to other, commercially-available microproppant particles.

Furthermore, in general, multiple stages of the wellbore are isolated, and hydraulic fracturing is performed for each stage. The microproppant coke particles described herein may be used in any number of the stages, including, for example, at least 2 stages, preferably at least 10 stages, and more preferably at least 20 stages.

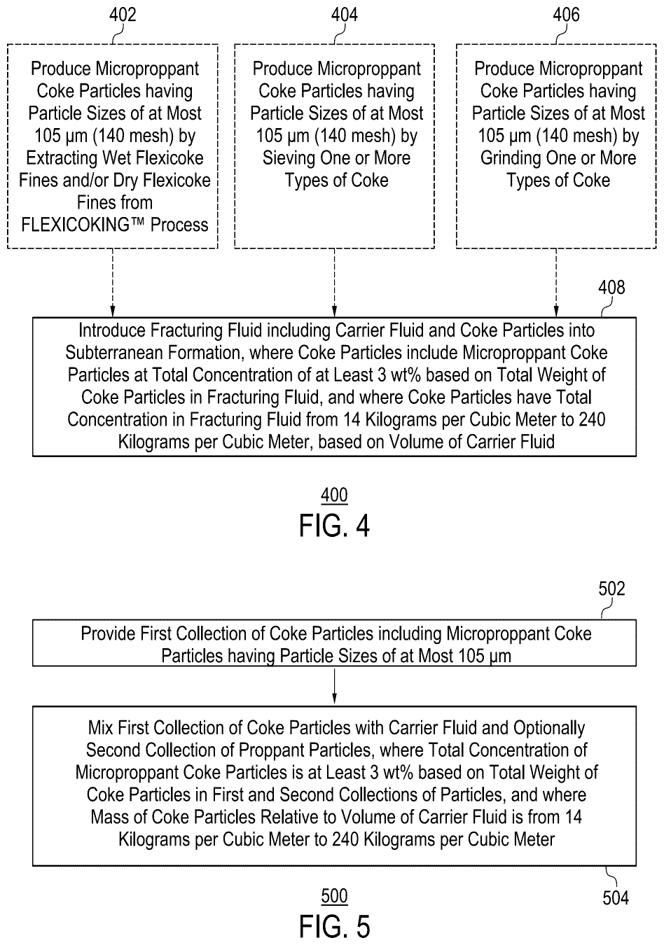

FIG. 4 is a process flow diagram of an exemplary method 400 of utilizing the fracturing fluid described herein during a hydraulic fracturing operation. The method 400 may begin at optional blocks 402, 404, and/or 406. Specifically, at optional block 402, microproppant coke particles with a particle size of at most 105 μm (140 mesh) are produced by extracting wet flexicoke fines and/or dry flexicoke fines from a FLEXICOKING™ process, as described herein. In some embodiments, the microproppant coke particles have a particle size of at most 88 μm (170 mesh). For some embodiments in which wet flexicoke fines are produced, such wet flexicoke fines may have a median particle size that is in a range from 8 μm to 22 μm. Other exemplary ranges of median particle size of wet flexicoke fines include around 8 μm to around 10 μm, around 10 μm to around 12 μm, around 12 μm to around 14 am, around 14 μm to around 16 am, around 16 μm to around 18 μm, around 18 μm to around 20 μm, and around 20 μm to around 22 μm, to give a few non-limiting examples. For some embodiments in which dry flexicoke fines are produced, such dry flexicoke fines may have a median particle size that is in a range from 6 am to 16 am. Other exemplary ranges of median particle size of dry flexicoke fines include around 6 μm to around 8 am, around 8 μm to around 10 am, around 10 μm to around 12 am, around 12 μm to around 14 am, and around 14 μm to around 16 am, to give a few non-limiting examples. In various embodiments, the wet and/or dry flexicoke fines have an apparent density that is in a range from 1.0 g/cm³ to 2.0 g/cm³ (or, in some embodiments, a range from 1.4 g/cm³ to 1.7 g/cm³). Other exemplary ranges of apparent density of wet and/or dry flexicoke fines include around 1.0 g/cm³ to around 1.2 g/cm³, around 1.2 g/cm³ to around 1.4 g/cm³, around 1.4 g/cm³ to around 1.6 g/cm³, around 1.6 g/cm³ to around 1.8 g/cm³, and around 1.8 g/cm³ to around 2.0 g/cm³, to list a few non-limiting examples.

Additionally or alternatively, at optional block 404, microproppant coke particles with particle sizes of at most 105 μm (140 mesh) are produced by sieving fluid coke, flexicoke, delayed coke, thermally post-treated coke, pyrolysis coke, coal-derived coke (e.g., blast furnace coke and/or metallurgical coke), and/or any other suitable type(s) of coke. In some embodiments, the microproppant coke particles have particle sizes of at most 88 am (170 mesh). In particular, sieves, filters, screens, and/or associated machinery are used to separate any suitable type(s) of bulk coke granules into larger particles as well as smaller particles that are suitable for utilization as the microproppant coke particles described herein. In various embodiments, the sieved fluid coke particles, sieved flexicoke particles, sieved delayed coke particles, sieved thermally post-treated coke particles, sieved pyrolysis coke particles, and/or sieved coal-derived coke (e.g., sieved blast furnace coke and/or sieved metallurgical coke) have an apparent density that is in a range from 1.0 g/cm³ to 2.0 g/cm³. Furthermore, in some embodiments, the sieved fluid coke particles, sieved flexicoke particles, sieved delayed coke particles, sieved thermally post-treated coke particles, sieved pyrolysis coke particles, and/or sieved coal-derived coke (e.g., sieved blast furnace coke and/or sieved metallurgical coke) have a median particle size that is in a range from 76 μm to 86 μm.

Additionally or alternatively, at optional block 406, microproppant coke particles with particle sizes of at most 105 μm (140 mesh) are produced by grinding fluid coke, flexicoke, delayed coke, thermally post-treated coke, pyrolysis coke, coal-derived coke (e.g., blast furnace coke and/or metallurgical coke), and/or any other suitable type(s) of coke. In some embodiments, the microproppant coke particles have particle sizes of at most 88 μm (170 mesh). Any suitable type(s) of grinding/milling technique(s) may be used for this purpose. For example, in some embodiments, coke granules may be processed using hammer milling techniques, jet milling techniques, ball milling techniques, or the like, where each of these techniques generally involves crushing or pulverizing the coke granules to a suitable size and shape. Moreover, those skilled in the art will appreciate that any number of other grinding, milling, or other processing techniques may be additionally or alternatively used, depending on the details of the particular implementation. In various embodiments, the ground fluid coke particles, ground flexicoke particles, ground delayed coke particles, ground thermally post-treated coke particles, ground pyrolysis coke particles, ground and/or ground coal-derived coke particles (e.g., ground blast furnace coke particles and/or ground metallurgical coke particles) have an apparent density that is in a range from 1.0 g/cm³ to 2.0 g/cm³.

At block 408, a fracturing fluid including a carrier fluid and coke particles is introduced into the subterranean formation (i.e., via injection through a wellbore during a hydraulic fracturing operation). The coke particles include the microproppant coke particles described herein (optionally as produced at blocks 402, 404, and/or 406). The microproppant coke particles are provided in the fracturing fluid at a concentration of at least 3 wt % based on the total weight of the coke particles in the fracturing fluid (where the weight percent of the particles may be determined prior to mixing the particles with the carrier fluid, e.g., on a dry particles basis). In some embodiments, the microproppant coke particles are provided in the fracturing fluid at a concentration that is in a range from 5 wt % to 100 wt % or, in some cases, a range from 30 wt % to 80 wt %, based on the total weight of the coke particles in the fracturing fluid. However, the exact concentration of the microproppant coke particles in the fracturing fluid will vary depending on the details of the particular implementation. Moreover, the coke particles have a total concentration in the fracturing fluid from around 14 kilograms per cubic meter to around 480 kilograms per cubic meter, based on the volume of the carrier fluid. In some embodiments, the coke particles have a total concentration from around 18 kilograms per cubic meter to around 120 kilograms per cubic meter, based on the volume of the carrier fluid. In some embodiments, the coke particles have a total concentration from around 23 kilograms per cubic meter to around 96 kilograms per cubic meter, based on the volume of the carrier fluid.

In some embodiments, the fracturing fluid may be introduced into the subterranean formation during a first interval of a hydraulic fracturing operation, with the microproppant coke particles having a total concentration of at least 50 wt % (e.g., ≥60 wt %, ≥70 wt %, ≥80 wt %, ≥90 wt %, ≥95 wt %, or even 100 wt %) based on the total weight of the coke particles within the fracturing fluid, and the fracturing fluid may also be introduced into the subterranean formation during a second interval of the hydraulic fracturing operation, with the microproppant coke particles having a total concentration of at most 20 wt % (e.g., ≤15 wt %, ≤10 wt %, ≤8 wt %, ≤5 wt %, and as low as 3 wt %) based on the total weight of the coke particles in the fracturing fluid. The first interval preferably precedes the second interval. The first interval may advantageously be a portion or the entirety of the pad phase. The second interval may advantageously be a portion of the entirety of the slurry phase. Due to the low density and small sizes of the microproppant coke particles, they can be successfully transported into cracks created in the earlier, first interval, including primary and secondary cracks, without causing screening out the cracks. In the later, second interval, the microproppant coke particles dispersed in the various cracks during the first interval and additional microproppant coke particles introduced during the second interval can be further transported to additional and more primary and secondary cracks created during the second interval.

In other embodiments, the fracturing fluid may be introduced into the subterranean formation during a first interval of the hydraulic fracturing operation, with the microproppant coke particles having a total concentration of at least 50 wt % (e.g., ≥60 wt %, ≥70 wt %, ≥80 wt %, ≥90 wt %, ≥95 wt %, or even 100 wt %) based on the total weight of the coke particles in the fracturing fluid, and a second fracturing fluid may be introduced into the subterranean formation during the second interval of the hydraulic fracturing operation, where the second fracturing fluid includes carrier fluid and second coke particles that include the microproppant coke particles at a total concentration of less than 3 wt % (e.g., ≤2.5 wt %, ≤2.0 wt %, ≤1 wt %, or even 0 wt %) based on the total weight of the second coke particles in the second fracturing fluid. The first interval preferably precedes the second interval. The first interval may advantageously be a portion or the entirety of the pad phase. The second interval may advantageously be a portion or the entirety of the slurry phase. Due to the low density and small sizes of the microproppant coke particles, they can be successfully transported into cracks created in the earlier, first interval, including primary and secondary cracks, without causing screening out of the cracks. In the later, second interval, the microproppant coke particles dispersed in the various cracks during the first interval can be further transported to additional and more primary and secondary cracks created during the second interval, making it unnecessary to further introduce any substantial amount of microproppant coke particles during the second interval. A particularly advantageous embodiment of this kind include: (i) during the pad phase, a fracturing fluid comprising only microproppant coke particles is injected into the wellbore to create a pad with initial primary and secondary cracks containing microproppant coke particles; and (ii) during a subsequent slurry phase, a second fracturing fluid substantially free of microproppant coke particles and containing coke particles having sizes greater than 105 μm is injected into the pad formed in the pad phase, whereby additional primary and secondary cracks are formed, and the microproppant coke particles dispersed in the initial cracks are further transported to additional primary and second cracks.

In some embodiments, the carrier fluid is an aqueous carrier fluid that includes water. In other embodiments, the carrier fluid is a non-aqueous carrier fluid that is substantially free of water. In other embodiments, the carrier fluid is liquid and/or supercritical CO₂. Moreover, in various embodiments, the fracturing fluid also includes one or more additives, such as one or more acids, one or more biocides, one or more breakers, one or more corrosion inhibitors, one or more crosslinkers, one or more friction reducers (e.g., polyacrylamides), one or more gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, one or more clay stabilizing agents, or any combination thereof.

In various embodiments, at least a portion of the microproppant coke particles are deposited within secondary fractures in the subterranean formation. Specifically, according to embodiments described herein, while a portion of the microproppant coke particles will likely deposit within the primary fracture(s), the microproppant coke particles are specifically designed to preferentially travel into and deposit within the secondary fractures as well as the primary fracture(s). This is due, at least in part, to the relatively small particle sizes and low density and correspondingly enhanced transport properties of such microproppant coke particles as compared to other types of proppant particles. Furthermore, in various embodiments, the method 400 includes introducing the fracturing fluid into the subterranean formation during at least a portion of the pad phase of the hydraulic fracturing operation, prior to the introduction of a second fracturing fluid including the carrier fluid and the second coke particles described herein and/or the third proppant particles described herein into the subterranean formation during, e.g., the slurry phase after the pad phase.

In other embodiments, the fracturing fluid itself includes the second coke particles (e.g., a second portion of coke particles having particle sizes of greater than 105 μm). Such second coke particles may include, but are not limited to, fluid coke particles, flexicoke particles, delayed coke particles, thermally post-treated coke particles, pyrolysis coke particles, and/or coal-derived coke particles (e.g., blast furnace coke particles and/or metallurgical coke particles), as described herein. In such embodiments, the method 400 may include introducing the fracturing fluid including the microproppant coke particles and the second coke particles into the subterranean formation during at least a portion of the pad phase of the hydraulic fracturing operation, as well as during at least a portion of the remainder of the hydraulic fracturing operation. The method 400 may further include preferentially depositing at least a portion of the microproppant coke particles within the secondary fractures in the subterranean formation and preferentially depositing the second coke particles within the primary fracture(s) in the subterranean formation.

Additionally or alternatively, in some embodiments, the fracturing fluid itself includes the third proppant particles described herein. Such third proppant particles may include, but are not limited to, sand and/or other types of non-coke proppant particles, LWP particles, and/or ULWP particles, as described herein. In such embodiments, the method 400 may include introducing the fracturing fluid including the microproppant coke particles and the third proppant particles into the subterranean formation during at least a portion of the pad phase of the hydraulic fracturing operation, as well as during at least a portion of the remainder of the hydraulic fracturing operation. The method 400 may further include preferentially depositing at least a portion of the microproppant coke particles within the secondary fractures in the subterranean formation and preferentially depositing the third proppant particles within the primary fracture(s) in the subterranean formation.

Furthermore, in various embodiments, the fracturing fluid is introduced into the subterranean formation via a stage of a hydrocarbon well. In such embodiments, the method 400 also includes repeating block 408 for each of a number of additional stages of the hydrocarbon well, such as at least 2 stages, preferably at least 10 stages, more preferably at least 20 stages, and, in some cases, all the stages of the hydrocarbon well.

Those skilled in the art will appreciate that the exemplary method 400 of FIG. 4 is susceptible to modification without altering the technical effect provided by the present disclosure. In practice, the exact manner in which the method 400 is implemented will depend, at least in part, on the details of the specific implementation.

FIG. 5 is a process flow diagram of an exemplary method 500 of making the fracturing fluid described herein. The method 500 begins at block 502, at which a first collection of coke particles including microproppant coke particles having particle sizes of at most 105 μm (140 mesh) are provided. In some embodiments, the particle sizes of the microproppant coke particles are at most 88 μm (170 mesh).

At block 504, a fracturing fluid is provided by mixing the microproppant coke particles with a carrier fluid and optionally a second collection of proppant particles, where the total concentration of the microproppant coke particles in the fracturing fluid is at least 3 wt % based on the total weight of the coke particles contained in the first collection of coke particles and the second collection of proppant particles, and the mass of the coke particles relative to the volume of the carrier fluid is from around 14 kilograms per cubic meter to around 240 kilograms per cubic meter Such mixing may be performed at a production site, either directly into a wellbore or by pre-mixing in a hopper or other mixing equipment. Any suitable type of mixing equipment may be utilized for this purpose, depending on the details of the particular implementation.

In various embodiments, the second collection of proppant particles includes non-coke particles (e.g., the third proppant particles described herein) and/or second coke particles that differ from the coke particles within the first collection of coke particles. In such embodiments, the non-coke particles may include but are not limited to sand, LWP, and/or ULWP. Moreover, in such embodiments, the second coke particles may have particle sizes of greater than 105 μm. Furthermore, in various embodiments, the first collection of coke particles may be substantially free of the second coke particles having particle sizes of greater than 105 μm.

In some embodiments, the first collection of coke particles also includes coke particles having particle sizes of greater than 105 μm, in addition to the microproppant coke particles. In some embodiments, block 504 includes mixing the first collection of coke particles, the carrier fluid, and the optional second collection of proppant particles with one or more additives. In such embodiments, such additive(s) may include, but are not limited to, an acid, a biocide, a breaker, a corrosion inhibitor, a crosslinker, a friction reducer, a gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and/or a clay stabilizing agent.

In some embodiments, the microproppant coke particles include petroleum coke fines, and the first collection of coke particles includes petroleum coke particles. In such embodiments, the microproppant coke particles may include wet flexicoke fines and/or dry flexicoke fines. In such embodiments, the method 500 may further include producing the wet flexicoke fines and/or the dry flexicoke fines via a FLEXICOKINTG™ process. Additionally or alternatively, in some embodiments, the microproppant coke particles include sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). In such embodiments, the method 500 may further include sieving fluid coke, flexicoke, delayed coke, thermally post-treated coke, pyrolysis coke, and/or coal-derived coke (e.g., blast furnace coke and/or metallurgical coke) to provide the microproppant coke particles with the particle size of at most 105 μm. Additionally or alternatively, in some embodiments, the microproppant coke particles include ground fluid coke, ground flexicoke, ground delayed coke, ground thermally post-treated coke, ground pyrolysis coke, and/or ground coal-derived coke (e.g., ground blast furnace coke and/or ground metallurgical coke). In such embodiments, the method 500 may further include grinding fluid coke, flexicoke, delayed coke, thermally post-treated coke, pyrolysis coke, and/or coal-derived coke (e.g., blast furnace coke and/or metallurgical coke) to provide the microproppant coke particles with the particle size of at most 105 μm.

In some embodiments, the carrier fluid includes an aqueous carrier fluid that includes water. In other embodiments, the carrier fluid includes a non-aqueous carrier fluid that is substantially free of water. In yet other embodiments, the carrier fluid includes liquid CO₂ and/or supercritical CO₂.

Those skilled in the art will appreciate that the exemplary method 500 of FIG. 5 is susceptible to modification without altering the technical effect provided by the present disclosure. In practice, the exact manner in which the method 500 is implemented will depend, at least in part, on the details of the specific implementation.

This disclosure can include one or more of the following non-limiting aspects and/or embodiments:

A1. A fracturing fluid comprising a carrier fluid and coke particles, wherein the coke particles comprise microproppant coke particles having particle sizes of at most 105 μm, the microproppant coke particles have a total concentration of at least 3 wt %, based on a total weight of the coke particles in the fracturing fluid, the coke particles have a total concentration in the fracturing fluid from 14 kilograms per cubic meter to 480 kilograms per cubic meter, based on the volume of the carrier fluid.

A1a. The fracturing fluid of A1, wherein the coke particles have a total concentration from 18 kilograms per cubic meter to 120 kilograms per cubic meter, based on the volume of the carrier fluid.

A1b. The fracturing fluid of A1, wherein the coke particles have a total concentration from 23 kilograms per cubic meter to 96 kilograms per cubic meter, based on the volume of the carrier fluid.

A2. The fracturing fluid of A1, wherein the microproppant coke particles have a total concentration of from 5 wt % to 100 wt %, based on the total weight of the coke particles in the fracturing fluid.

A3. The fracturing fluid of A1, wherein the microproppant coke particles have a total concentration of from 30 wt % to 80 wt %, based on the total weight of the coke particles in the fracturing fluid.

A4. The fracturing fluid of any of A1 to A3, wherein the microproppant coke particles comprise petroleum coke fines, and wherein the coke particles comprise petroleum coke particles.

A5. The fracturing fluid of A4, wherein the microproppant coke particles comprise at least one of wet flexicoke fines and dry flexicoke fines.

A6. The fracturing fluid of A5, wherein the wet flexicoke fines have a median particle size that is in a range from 8 μm to 22 μm.

A7. The fracturing fluid of A5 or A6, wherein the dry flexicoke fines have a median particle size that is in a range from 6 μm to 16 μm.

A8. The fracturing fluid of any of A4 to A7, wherein the microproppant coke particles comprise fluid coke particles.

A9. The fracturing fluid of any of A1 to A8, wherein the microproppant coke particles have an apparent density in a range from 1.0 g/cm³ to 2.0 g/cm³.

A10. The fracturing fluid of any of A1 to A9, wherein the microproppant coke particles comprise at least one of: sieved fluid coke, sieved flexicoke, sieved delayed coke, sieved thermally post-treated coke, sieved pyrolysis coke, and sieved coal-derived coke.

A11. The fracturing fluid of A10, wherein the at least one of the sieved fluid coke, the sieved flexicoke, the sieved delayed coke, the sieved thermally post-treated coke, the sieved pyrolysis coke, and the sieved coal-derived coke has a median particle size that is in a range from 76 μm to 86 μm.

A12. The fracturing fluid of any of A1 to A11, wherein the microproppant coke particles comprise at least one of: ground fluid coke, ground flexicoke, ground delayed coke, ground thermally post-treated coke, ground pyrolysis coke, and ground coal-derived coke.

A13. The fracturing fluid of any of A1 to A12, wherein the coke particles further comprise a second portion having particle sizes of greater than 105 μm.

A14. The fracturing fluid of A13, wherein the microproppant coke particles are designed to preferentially settle within secondary fractures in the subterranean formation in addition to primary fractures in the subterranean formation, while the second portion are designed to preferentially settle within the primary fractures in the subterranean formation.

A15. The fracturing fluid of any of A1 to A14, further comprising third proppant particles differing from the coke particles.

A16. The fracturing fluid of A15, wherein the third proppant particles comprise sand.

A17. The fracturing fluid of A15 or A16, wherein the third proppant particles comprise at least one of LWP and ULWP.

A18. The fracturing fluid of any of A1 to A17, wherein the carrier fluid comprises water.

A19. The fracturing fluid of any of A1 to A17, wherein the carrier fluid is substantially free of water.

A20. The fracturing fluid of any of A1 to A19, wherein the carrier fluid comprises at least one of liquid CO₂ and supercritical CO₂.

A21. The fracturing fluid of any of A1 to A20, further comprising at least one of: an acid, a biocide, a breaker, a corrosion inhibitor, a crosslinker, a friction reducer, a gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

B1. A method, comprising: (I) introducing a fracturing fluid into a subterranean formation, the fracturing fluid comprising a carrier fluid and coke particles, wherein the coke particles comprise microproppant coke particles having particle sizes of at most 105 μm at a concentration of at least 3 wt %, based on a total weight of the coke particles in the fracturing fluid; the coke particles have a total concentration in the fracturing fluid from 14 kilograms per cubic meter to 480 kilograms per cubic meter, based on the volume of the carrier fluid.

B1a. The fracturing fluid of B1, wherein the coke particles have a total concentration from 18 kilograms per cubic meter to 120 kilograms per cubic meter, based on the volume of the carrier fluid.

B1b. The fracturing fluid of B1, wherein the coke particles have a total concentration from 23 kilograms per cubic meter to 96 kilograms per cubic meter, based on the volume of the carrier fluid.

B2. The method of B1, wherein the microproppant coke particles have a total concentration of from 5 wt % to 100 wt %, based on the total weight of the coke particles in the fracturing fluid.

B3. The method of B1, wherein the microproppant coke particles have a total concentration of from 30 wt % to 80 wt %, based on the total weight of the coke particles in the fracturing fluid.

B4. The method of any of B1 to B3, wherein the microproppant coke particles comprise petroleum coke fines, and wherein the coke particles comprise petroleum coke particles.

B5. The method of B4, wherein the microproppant coke particles comprise at least one of wet flexicoke fines and dry flexicoke fines.

B6. The method of B5, wherein the method further comprises producing the at least one of the wet flexicoke fines and the dry flexicoke fines via a FLEXICOKING™ process.

B7. The method of B5 or B6, wherein the wet flexicoke fines have a median particle size that is in a range from 8 μm to 22 μm.

B8. The method of any of B5 to B7, wherein the dry flexicoke fines have a median particle size that is in a range from 6 μm to 16 μm.

B9. The method of any of B4 to B8, wherein the microproppant coke particles comprise fluid coke particles.

B10. The method of any of B1 to B9, wherein the microproppant coke particles have an apparent density in a range from 1.0 g/cm³ to 2.0 g/cm³.

B11. The method of any of B1 to B10, wherein the microproppant coke particles comprise at least one of: sieved fluid coke, sieved flexicoke, sieved delayed coke, sieved thermally post-treated coke, sieved pyrolysis coke, and sieved coal-derived coke.

B12. The method of B11, wherein the at least one of the sieved fluid coke, the sieved flexicoke, the sieved delayed coke, the sieved thermally post-treated coke, the sieved pyrolysis coke, and the sieved coal-derived coke has a median particle size that is in a range from 76 μm to 86 μm.

B13. The method of B11 or B12, wherein the method further comprises sieving at least one of fluid coke, flexicoke, delayed coke, thermally post-treated coke, pyrolysis coke, and coal-derived coke to obtain the microproppant coke particles with particle sizes of at most 105 μm.

B14. The method of any of B1 to B13, wherein the microproppant coke particles comprise at least one of: ground fluid coke, ground flexicoke, ground delayed coke, ground thermally post-treated coke, ground pyrolysis coke, and ground coal-derived coke.

B15. The method of B14, wherein the method further comprises grinding at least one of fluid coke, flexicoke, delayed coke, thermally post-treated coke, pyrolysis coke, and coal-derived coke to obtain the microproppant coke particles with particle sizes of at most 105 μm.

B16. The method of any of B1 to B15, comprising introducing the fracturing fluid into the subterranean formation during a pad phase of a hydraulic fracturing operation, prior to an introduction of a second fracturing fluid comprising the carrier fluid and at least one of the following into the subterranean formation: (i) second proppant particles that comprise second coke particles but substantially free of the microproppant coke particles; and (ii) third proppant particles substantially free of coke particles.

B17. The method of any of B1 to B16, wherein the coke particles further comprises a second portion having particle sizes of greater than 105 μm.

B18. The method of B17, wherein step (I) is carried out during a pad phase of a hydraulic fracturing operation.

B18a. The method of B18, wherein the hydraulic fracturing fluid is substantially free of proppant particles having a size greater than 105 μm.

B18b. The method of B18, wherein the fracturing fluid comprises the microproppant coke particles at a concentration of at least 80 wt %, based on the total weight of all microproppant particles present in the fracturing fluid.

B19. The method of any of B1 to B18b, wherein the fracturing fluid further comprises third proppant particles differing from the coke particles.

B20. The method of B19, wherein the third proppant particles comprise sand.

B21. The method of B19 or B20, wherein the third proppant particles comprise at least one of LWP and ULWP.

B22. The method of any of B19 to B21, wherein step (I) is carried out during a slurry phase of a hydraulic fracturing operation.

B22a. The method of B22, wherein the hydraulic fracturing fluid further comprises second coke particles having sizes greater than 105 μm.

B22b. The method of B22, wherein the fracturing fluid comprises the microproppant coke particles at a concentration of no greater than 10 wt %, based on the total weight of all coke particles present in the fracturing fluid.

B23. The method of any of B1 to B22b, comprising a first interval and a second interval, wherein: during the first interval, the microproppant coke particles have a total concentration of at least 50 wt %, based on the total weight of the coke particles in the fracturing fluid; and during the second interval, the microproppant coke particles have a total concentration of at most 20 wt %, based on the total weight of the coke particles in the fracturing fluid.

B24. The method of any of B1 to B22b, comprising a first interval and a second interval, wherein: during the first interval, step (I) is carried out, wherein the microproppant coke particles have a total concentration of at least 50 wt %, based on the total weight of the coke particles in the fracturing fluid; and during the second interval, the following is carried out: introducing a second fracturing fluid comprising the carrier fluid and second coke particles, wherein the second coke particles comprise the microproppant coke particles at a total concentration of less than 3 wt % based on a total weight of the second coke particles in the second fracturing fluid.

B25. The method of any of B1 to B24, wherein the carrier fluid comprises water.

B26. The method of any of B1 to B24, wherein the carrier fluid is substantially free of water.

B27. The method of any of B1 to B26, wherein the carrier fluid comprises at least one of liquid CO₂ and supercritical CO₂.

B28. The method of any of B1 to B27, wherein the fracturing fluid further comprises at least one of an acid, a biocide, a breaker, a corrosion inhibitor, a crosslinker, a friction reducer, a gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

B29. The method of any of B1 to B28, wherein the fracturing fluid is introduced into the subterranean formation via a stage of a hydrocarbon well, and wherein the method further comprises repeating the introduction of the fracturing fluid and the deposition of the at least the portion of the microproppant coke particles for each of a plurality of additional stages of the hydrocarbon well.

C1. A method for making a fracturing fluid, comprising: providing a first collection of coke particles comprising microproppant coke particles, wherein the microproppant coke particles have particle sizes of at most 105 m; and mixing the first collection of coke particles with a carrier fluid and optionally a second collection of proppant particles, wherein a total concentration of the microproppant coke particles is at least 3 wt % based on a total weight of the coke particles contained in the first collection of coke particles and the second collection of proppant particles; and the mass of the coke particles relative to the volume of the carrier fluid is from 14 kilograms per cubic meter to 240 kilograms per cubic meter.

C1a. The fracturing fluid of C1, wherein the mass of the coke particles relative to the volume of the carrier fluid is from 18 kilograms per cubic meter to 120 kilograms per cubic meter.

C1b. The fracturing fluid of C1, wherein the mass of the coke particles relative to the volume of the carrier fluid is from 23 kilograms per cubic meter to 96 kilograms per cubic meter.

C2. The method of any of C1, C1a, and C1b, wherein the particle sizes of the microproppant coke particles are at most 88 μm.

C3. The method of C1 or C2, wherein the second collection of proppant particles comprises at least one of non-coke particles and second coke particles that differ from the coke particles within the first collection of coke particles.

C4. The method of C3, wherein the non-coke particles comprise at least one of sand, a LWP, and ULWP.

C5. The method of C3 or C4, wherein the second coke particles have particle sizes of greater than 105 μm.

C6. The method of C5, wherein the first collection of coke particles is substantially free of the second coke particles having particle sizes of greater than 105 μm.

C7. The method of any of C1 to C5, wherein the first collection of coke particles further comprises coke particles having particle sizes of greater than 105 μm.

C8. The method of any of C1 to C7, further comprising mixing the first collection of coke particles, the carrier fluid, and the optional second collection of proppant particles with at least one additive.

C9. The method of C8, wherein the additive comprises at least one of: an acid, a biocide, a breaker, a corrosion inhibitor, a crosslinker, a friction reducer, a gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

C10. The method of any of C1 to C9, wherein the microproppant coke particles comprise petroleum coke fines, and wherein the first collection of coke particles comprise petroleum coke particles.

C11. The method of C10, wherein the microproppant coke particles comprise at least one of wet flexicoke fines and dry flexicoke fines.

C12. The method of C11, wherein the method further comprises producing the at least one of the wet flexicoke fines and the dry flexicoke fines via a FLEXICOKING™ process.

C13. The method of any of C1 to C12, wherein the microproppant coke particles comprise at least one of: sieved fluid coke, sieved flexicoke, sieved delayed coke, sieved thermally post-treated coke, sieved pyrolysis coke, and sieved coal-derived coke.

C14. The method of C13, wherein the method further comprises sieving at least one of fluid coke, flexicoke, delayed coke, thermally post-treated coke, pyrolysis coke, and coal-derived coke to provide the microproppant coke particles having particle sizes of at most 105 μm.

C15. The method of any of C1 to C14, wherein the microproppant coke particles comprise at least one of: ground fluid coke, ground flexicoke, ground delayed coke, ground thermally post-treated coke, ground pyrolysis coke, and ground coal-derived coke.

C16. The method of C15, wherein the method further comprises grinding at least one of fluid coke, flexicoke, delayed coke, thermally post-treated coke, pyrolysis coke, and coal-derived coke to provide the microproppant coke particles with particle sizes of at most 105 μm.

C17. The method of any of C1 to C16, wherein the carrier fluid comprises water.

C18. The method of any of C1 to C16, wherein the carrier fluid is substantially free of water.

C19. The method of any of C1 to C18, wherein the carrier fluid comprises at least one of liquid CO₂ and supercritical CO₂.

While the aspects and embodiments described herein are well-calculated to achieve the advantages set forth, it will be appreciated that such aspects and embodiments are susceptible to modification, variation, and change without departing from the spirit thereof. In other words, the particular aspects and embodiments described herein are illustrative only, as the teachings of the present techniques may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A fracturing fluid comprising a carrier fluid and coke particles, wherein:
the coke particles comprise microproppant coke particles having particle sizes of at most 105 microns (μm);
the microproppant coke particles have a total concentration of at least 3 weight percent (wt %), based on a total weight of the coke particles in the fracturing fluid; and
the coke particles have a total concentration in the fracturing fluid from 14 kilograms per cubic meter to 480 kilograms per cubic meter, based on the volume of the carrier fluid.

2. The fracturing fluid of claim 1, wherein the coke particles have a total concentration from 18 kilograms per cubic meter to 120 kilograms per cubic meter, based on the volume of the carrier fluid.

3. The fracturing fluid of claim 1, wherein the coke particles have a total concentration from 23 kilograms per cubic meter to 96 kilograms per cubic meter, based on the volume of the carrier fluid.

4. The fracturing fluid of claim 1, wherein the microproppant coke particles have a total concentration of from 5 wt % to 100 wt %, based on the total weight of the coke particles in the fracturing fluid.

5. The fracturing fluid of claim 1, wherein the microproppant coke particles have a total concentration of from 30 wt % to 80 wt %, based on the total weight of the coke particles in the fracturing fluid.

6. The fracturing fluid of claim 1, wherein the microproppant coke particles comprise petroleum coke fines, and wherein the coke particles comprise petroleum coke particles.

7. The fracturing fluid of claim 4, wherein the microproppant coke particles comprise at least one of wet flexicoke fines and dry flexicoke fines.

8. The fracturing fluid of claim 7, wherein the wet flexicoke fines have a median particle size in a range from 8 μm to 22 μm.

9. The fracturing fluid of claim 7, wherein the dry flexicoke fines have a median particle size in a range from 6 μm to 16 μm.

10. The fracturing fluid of claim 1 wherein the microproppant coke particles comprise fluid coke particles.

11. The fracturing fluid of claim 1, wherein the microproppant coke particles comprise at least one of: sieved fluid coke, sieved flexicoke, sieved delayed coke, sieved thermally post-treated coke, sieved pyrolysis coke, and sieved coal-derived coke.

12. The fracturing fluid of claim 11, wherein the at least one of the sieved fluid coke, the sieved flexicoke, the sieved delayed coke, the sieved thermally post-treated coke, the sieved pyrolysis coke, and the sieved coal-derived coke has a median particle size that is in a range from 76 μm to 86 μm.

13. The fracturing fluid of claim 1, wherein the microproppant coke particles comprise at least one of: ground fluid coke, ground flexicoke, ground delayed coke, ground thermally post-treated coke, ground pyrolysis coke, and ground coal-derived coke.

14. The fracturing fluid of claim 1, wherein the coke particles further comprise a second portion having particle sizes of greater than 105 μm.

15. The fracturing fluid of claim 1, further comprising third proppant particles differing from the coke particles.

16. The fracturing fluid of claim 15, wherein the third proppant particles comprise sand.

17. The fracturing fluid of claim 15, wherein the third proppant particles comprise at least one of lightweight proppant (LWP) and ultra-lightweight proppant (ULWP).

18. The fracturing fluid of claim 1, wherein the carrier fluid comprises water.

19. The fracturing fluid of claim 1, wherein the carrier fluid is substantially free of water.

20. The fracturing fluid of claim 1, wherein the carrier fluid comprises at least one of liquid carbon dioxide (CO₂) and supercritical CO₂.

21. The fracturing fluid of claim 1, further comprising at least one of: an acid, a biocide, a breaker, a corrosion inhibitor, a crosslinker, a friction reducer, a gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

22. A method, comprising:
(I) introducing a fracturing fluid into a subterranean formation, the fracturing fluid comprising a carrier fluid and coke particles, wherein the coke particles comprise microproppant coke particles having particle sizes of at most 105 microns (μm) at a concentration of at least 3 weight percent (wt %), based on a total weight of the coke particles in the fracturing fluid, and wherein the coke particles have a total concentration in the fracturing fluid from 14 kilograms per cubic meter to 240 kilograms per cubic meter, based on the volume of the carrier fluid.

23. The fracturing fluid of claim 22, wherein the coke particles have a total concentration from 18 kilograms per cubic meter to 120 kilograms per cubic meter, based on the volume of the carrier fluid.

24. The fracturing fluid of claim 22, wherein the coke particles have a total concentration from 23 kilograms per cubic meter to 96 kilograms per cubic meter, based on the volume of the carrier fluid.

25. The method of claim 22, wherein the microproppant coke particles have a total concentration of from 5 wt % to 100 wt %, based on the total weight of the coke particles in the fracturing fluid.

26. The method of claim 22, wherein the microproppant coke particles have a total concentration of from 30 wt % to 80 wt %, based on the total weight of the coke particles in the fracturing fluid.

27. The method of claim 22, wherein the microproppant coke particles comprise petroleum coke fines, and wherein the coke particles comprise petroleum coke particles.

28. The method of claim 27, wherein the microproppant coke particles comprise at least one of wet flexicoke fines and dry flexicoke fines.

29. The method of claim 28, wherein the method further comprises producing the at least one of the wet flexicoke fines and the dry flexicoke fines via a FLEXICOKING™ process.

30. The method of claim 28, wherein the wet flexicoke fines have a median particle size that is in a range from 8 μm to 22 μm.

31. The method of claim 28, wherein the dry flexicoke fines have a median particle size that is in a range from 6 μm to 16 μm.

32. The method of claim 27, wherein the microproppant coke particles comprise fluid coke particles.

33. The method of claim 22, wherein the microproppant coke particles have an apparent density in a range from 1.0 gram per cubic centimeter (g/cm³) to 2.0 g/cm³.

34. The method of claim 22, wherein the microproppant coke particles comprise at least one of: sieved fluid coke, sieved flexicoke, sieved delayed coke, sieved thermally post-treated coke, sieved pyrolysis coke, and sieved coal-derived coke.

35. The method of claim 34, wherein the at least one of the sieved fluid coke, the sieved flexicoke, the sieved delayed coke, the sieved thermally post-treated coke, the sieved pyrolysis coke, and the sieved coal-derived coke has a median particle size that is in a range from 76 μm to 86 μm.

36. The method of claim 34, wherein the method further comprises sieving at least one of fluid coke, flexicoke, delayed coke, thermally post-treated coke, pyrolysis coke, and coal-derived coke to obtain the microproppant coke particles with particle sizes of at most 105 μm.

37. The method of claim 22, wherein the microproppant coke particles comprise at least one of: ground fluid coke, ground flexicoke, ground delayed coke, ground thermally post-treated coke, ground pyrolysis coke, and ground coal-derived coke.

38. The method of claim 37, wherein the method further comprises grinding at least one of fluid coke, flexicoke, delayed coke, thermally post-treated coke, pyrolysis coke, and coal-derived coke to obtain the microproppant coke particles with particle sizes of at most 105 μm.

39. The method of claim 22, comprising introducing the fracturing fluid into the subterranean formation during a pad phase of a hydraulic fracturing operation, prior to an introduction of a second fracturing fluid comprising the carrier fluid and at least one of the following into the subterranean formation: (i) second proppant particles that comprise second coke particles but substantially free of the microproppant coke particles; and (ii) third proppant particles that are substantially free of coke particles.

40. The method of claim 22, wherein the coke particles further comprises a second portion having particle sizes of greater than 105 μm.

41. The method of claim 22, wherein step (I) is carried out during a pad phase of a hydraulic fracturing operation.

42. The method of claim 41, wherein the hydraulic fracturing fluid is substantially free of proppant particles having a size greater than 105 μm.

43. The method of claim 41, wherein the fracturing fluid comprises the microproppant coke particles at a concentration of at least 80 wt %, based on the total weight of all microproppant particles present in the fracturing fluid.

44. The method of claim 22, wherein the fracturing fluid further comprises third proppant particles differing from the coke particles.

45. The method of claim 44, wherein the third proppant particles comprise sand.

46. The method of claim 44, wherein the third proppant particles comprise at least one of lightweight proppant (LWP) and ultra-lightweight proppant (ULWP).

47. The method of claim 22, wherein step (I) is carried out at least during a slurry phase of a hydraulic fracturing operation.

48. The method of claim 47, wherein the hydraulic fracturing fluid further comprises second coke particles having sizes greater than 105 μm.

49. The method of claim 44, wherein the fracturing fluid comprises the microproppant coke particles at a concentration of no greater than 10 wt %, based on the total weight of all coke particles present in the fracturing fluid.

50. The method of claim 22, comprising a first interval and a second interval, wherein:
during the first interval, the microproppant coke particles have a total concentration of at least 50 wt %, based on the total weight of the coke particles in the fracturing fluid; and
during the second interval, the microproppant coke particles have a total concentration of at most 20 wt %, based on the total weight of the coke particles in the fracturing fluid.

51. The method of claim 22, comprising a first interval and a second interval, wherein:
during the first interval, step (I) is carried out, wherein the microproppant coke particles have a total concentration of at least 50 wt %, based on the total weight of the coke particles in the fracturing fluid; and
during the second interval, the following is carried out:
introducing a second fracturing fluid comprising the carrier fluid and second coke particles, wherein the second coke particles comprise the microproppant coke particles at a total concentration of less than 3 wt % based on a total weight of the second coke particles in the second fracturing fluid.

52. A method for making a fracturing fluid, comprising:
providing a first collection of coke particles comprising microproppant coke particles, wherein the microproppant coke particles have particle sizes of at most 105 microns (μm); and
mixing the first collection of coke particles with a carrier fluid and optionally a second collection of proppant particles, wherein a total concentration of the microproppant coke particles is at least 3 weight percent (wt %) based on a total weight of coke particles contained in the first collection of coke particles and the second collection of proppant particles; and wherein the mass of the coke particles relative to the volume of the carrier fluid is from 14 kilograms per cubic meter to 240 kilograms per cubic meter.

53. The method of claim 52, wherein the mass of the coke particles relative to the volume of the carrier fluid is from 18 kilograms per cubic meter to 120 kilograms per cubic meter.

54. The method of claim 52, wherein the mass of the coke particles relative to the volume of the carrier fluid is from 23 kilograms per cubic meter to 96 kilograms per cubic meter.

55. The method of claim 52, wherein the particle sizes of the microproppant coke particles are at most 88 μm.

56. The method of claim 52, wherein the second collection of proppant particles comprises at least one of non-coke particles and second coke particles that differ from the coke particles within the first collection of coke particles.

57. The method of claim 56, wherein the non-coke particles comprise at least one of sand, a lightweight proppant (LWP), and an ultra-lightweight proppant (ULWP).

58. The method of claim 56, wherein the second coke particles have particle sizes of greater than 105 μm.

59. The method of claim 58, wherein the first collection of coke particles is substantially free of the second coke particles having particle sizes of greater than 105 μm.

60. The method of claim 52, wherein the first collection of coke particles further comprises coke particles having particle sizes of greater than 105 μm.

61. The method of claim 52, further comprising mixing the first collection of coke particles, the carrier fluid, and the optional second collection of proppant particles with at least one additive.

62. The method of claim 52, wherein the microproppant coke particles comprise petroleum coke fines, and wherein the first collection of coke particles comprise petroleum coke particles.

63. The method of claim 62, wherein the microproppant coke particles comprise at least one of wet flexicoke fines and dry flexicoke fines.

64. The method of claim 63, wherein the method further comprises producing the at least one of the wet flexicoke fines and the dry flexicoke fines via a FLEXICOKING™ process.

65. The method of claim 52, wherein the microproppant coke particles comprise at least one of: sieved fluid coke, sieved flexicoke, sieved delayed coke, sieved thermally post-treated coke, sieved pyrolysis coke, and sieved coal-derived coke.

66. The method of claim 65, wherein the method further comprises sieving at least one of fluid coke, flexicoke, delayed coke, thermally post-treated coke, pyrolysis coke, and coal-derived coke to provide the microproppant coke particles having particle sizes of at most 105 μm.

67. The method of claim 52, wherein the microproppant coke particles comprise at least one of: ground fluid coke, ground flexicoke, ground delayed coke, ground thermally post-treated coke, ground pyrolysis coke, and ground coal-derived coke.

68. The method of claim 67, wherein the method further comprises grinding at least one of fluid coke, flexicoke, delayed coke, thermally post-treated coke, pyrolysis coke, and coal-derived coke to provide the microproppant coke particles with particle sizes of at most 105 μm.
